(19) United States
(12) Patent Application Publication
(10) Pub. No.: US 2014/0257973 A1
(43) Pub. Date: Sep. 11, 2014

(54) Systems and Methods for Scoring Keywords and Phrases used in Targeted Search Advertising Campaigns

(71) Applicant: DATAPOP, INC., Los Angeles, CA (US)

(72) Inventors: Behzad Zamanzadeh, Tarzana, CA (US); Cartic Ramakrishnan, Los Angeles, CA (US); Jonathan Warden, Chicago, IL (US); Man Chiu Hon, Alhambra, CA (US)

(73) Assignee: DataPop, Inc., Los Angeles, CA (US)

(21) Appl. No.: 13/792,909

(22) Filed: Mar. 11, 2013

(51) Int. Cl. G06Q 30/02

(52) U.S. Cl. CPC G06Q 30/0246; G06Q 30/0256
USPC 705/14.45; 705/14.41

(57) ABSTRACT

Systems and methods for scoring phrases and keywords utilized in the generation of targeted search advertising campaigns in accordance with embodiments of the invention are disclosed. In one embodiment, a keyword and phrase scoring device includes a processor, a keyword and phrase scoring application, phrase key data, and language model performance data including category and attribute data with associated keywords and keyword performance data, wherein the keyword and phrase scoring application configures the processor to obtain a plurality of unscored keywords, identify keyword patterns in a portion of the plurality of unscored keywords, generate a keyword model based on a set of key columns, create a training language model incorporating phrase key data from the key columns using category and attribute data within the language model performance data, and score the plurality of unscored keywords based on the keyword model and the training language model.

### FIELD OF THE INVENTION

The present invention relates to targeted search advertising and more specifically to the determination of keywords and creatives for use in targeted search advertising campaigns.

### BACKGROUND

The term e-commerce is used to refer to the buying and selling of products or services over electronic systems such as the Internet and other computer networks. The amount of trade conducted via e-commerce has grown extraordinarily with widespread Internet usage. As a result, a variety of websites have been established to offer goods and services.

Search engines are useful tools for locating specific pages of information on the World Wide Web and are increasingly used to locate goods and services. As a result, many websites use search advertising/search engine marketing to attract visitors to product, service, and/or category landing pages. Search advertising describes the placement of online advertisements adjacent or amongst the search results returned by a search engine in response to a specific search query. Search engine marketing typically involves paying for a specific online advertisement or creative to be featured in or adjacent to the search results provided in response to a specific query. Typically, the position of an advertisement within the returned search results is a function of the bid scaled by a quality factor that measures the relevance of the creative and landing page combination to the search query. Accordingly, the provider of the search engine is incentivized to feature relevant keyword/advertisement/landing page combinations so that users will select featured advertisements and increase the revenue generated by the search engine provider. In the context of paid search advertising, the term keyword refers to both a single word and a specific combination of words or keyword components.

When a website includes a large number of products or services, the process of building and managing a paid search advertising campaign can be quite complex. Many search engines provide the ability to upload an entire advertising campaign including one or more creatives that target a set of keywords, and associated bids to be used when the display of the creative is triggered by specific keywords. For example, Google, Inc. of Mountain View, Calif., defines an Ad Group file format that enables advertisers to upload paid search advertising campaigns.

### SUMMARY OF THE INVENTION

Systems and methods for scoring phrases and keywords utilized in the generation of targeted search advertising campaigns in accordance with embodiments of the invention are disclosed. In one embodiment, a keyword and phrase scoring device includes a processor, a memory connected to the processor and configured to store a keyword and phrase scoring application, a shared phrase key database configured to store phrase key data, and performance data storage configured to store language model performance data including category and attribute data with associated keywords and keyword performance data, wherein the keyword and phrase scoring application configures the processor to obtain a plurality of unscored keywords, identify keyword patterns in a portion of the plurality of unscored keywords, generate a keyword model based on a set of key columns, where the key columns are based on phrase keys contained within the identified patterns and corresponding phrase key data contained within the shared phrase key database, create a training language model incorporating phrase key data from the key columns using category and attribute data within the language model performance data matching phrase key data contained within the shared phrase key database, and score the plurality of unscored keywords based on the keyword model and the training language model.

In another embodiment of the invention, the keyword and phrase scoring application further configures the processor to determine at least one phrase structure within the plurality of unscored keywords and identify keyword patterns in a portion of the plurality of unscored keywords based on the at least one phrase structure.

In an additional embodiment of the invention, the identified keyword patterns are selected from the group consisting of phrase patterns, concept patterns, and grammar patterns.

In yet another additional embodiment of the invention, the keyword and phrase scoring application further configures the processor to extract a plurality of performance keywords from the language model performance data based on the shared phrase key database, identify one or more patterns within the plurality of performance keywords, and create the language training model based on the identified patterns.

In still another additional embodiment of the invention, the keyword and phrase scoring application further configures the processor to count the number of patterns within the plurality of performance keywords.

In yet still another additional embodiment of the invention, the keyword and phrase scoring application further configures the processor to update the language model performance data based on the scored keywords.

In yet another embodiment of the invention, the keyword and phrase scoring application further configures the processor to update the language model performance data based on the created language training model.

In still another embodiment of the invention, the keyword and phrase scoring application further configures the processor to obtain keyword frequency metadata, where the keyword frequency metadata includes the number of times one or more keywords have been received by a search engine provider and prioritize the scored keywords based on the keyword frequency metadata.

In yet still another embodiment of the invention, the keyword frequency metadata further includes performance metrics related to the number of times an advertisement has been displayed based on a search query containing the one or more keywords by the search engine provider and the performance metrics are selected from the group consisting of a click-through rate and a conversion rate.

In still another additional embodiment of the invention, the keyword and phrase scoring application further configures the processor to transmit the scored keywords to an advertising server system.

Yet another embodiment of the invention includes a method for scoring phrases including obtaining a plurality of unscored keywords using a keyword and phrase scoring device, identifying keyword patterns in a portion of the plurality of unscored keywords using the keyword and phrase scoring device, generating a keyword model based on a set of key columns using the keyword and phrase scoring device, where the key columns are based on phrase keys contained within the identified patterns and corresponding phrase key data contained within the shared phrase key database, creating a training language model incorporating phrase key data from the key columns based on category and attribute data within the language model performance data matching phrase key data contained within the shared phrase key database using the keyword and phrase scoring device, and scoring the plurality of unscored keywords based on the keyword model and the training language model using the keyword and phrase scoring device.

In yet another additional embodiment of the invention, scoring phrases further includes determining at least one phrase structure within the plurality of unscored keywords using the keyword and phrase scoring device and identifying keyword patterns in a portion of the plurality of unscored keywords based on the at least one phrase structure using the keyword and phrase scoring device.

In still another additional embodiment of the invention, the identified keyword patterns are selected from the group consisting of phrase patterns, concept patterns, and grammar patterns.

In yet still another additional embodiment of the invention, scoring phrases further includes extracting a plurality of performance keywords from the language model performance data based on the shared phrase key database using the keyword and phrase scoring device, identifying one or more patterns within the plurality of performance keywords using the keyword and phrase scoring device, and creating the language training model based on the identified patterns using the keyword and phrase scoring device.

In yet another embodiment of the invention, scoring phrases further includes counting the number of patterns within the plurality of performance keywords using the keyword and phrase scoring device.

In still another embodiment of the invention, scoring phrases further includes updating the language model performance data based on the scored keywords using the keyword and phrase scoring device.

In yet still another embodiment of the invention, scoring phrases further includes updating the language model performance data based on the created language training model using the keyword and phrase scoring device.

In yet another embodiment of the invention, scoring phrases further includes obtaining keyword frequency metadata using the keyword and phrase scoring device, where the keyword frequency metadata includes the number of times one or more keywords have been received by a search engine provider and prioritizing the scored keywords based on the keyword frequency metadata using the keyword and phrase scoring device.

In still another additional embodiment of the invention, the keyword frequency metadata further includes performance metrics related to the number of times an advertisement has been displayed based on a search query containing the one or more keywords by the search engine provider and the performance metrics are selected from the group consisting of a click-through rate and a conversion rate.

In yet still another additional embodiment of the invention, scoring phrases further includes transmitting the scored keywords to an advertising server system using the keyword and phrase scoring device.

### BRIEF DESCRIPTION OF THE DRAWINGS

FIG. 1 is a conceptual illustration of a targeted advertising system in accordance with an embodiment of the invention.

FIG. 2 is a conceptual illustration of a keyword and phrase scoring device in accordance with an embodiment of the invention.

FIG. 3 is a flow chart illustrating a process for scoring keywords and phrases based on a training language model in accordance with an embodiment of the invention.

FIG. 4 is a flow chart illustrating a process for creating a keyword model in accordance with an embodiment of the invention.

FIG. 5 is a flow chart illustrating a process for creating a training language model in accordance with an embodiment of the invention.

### DETAILED DESCRIPTION

Turning now to the drawings, systems and methods for scoring keywords and phrases utilized in targeted search advertising campaigns in accordance with embodiments of the invention are disclosed. Targeted search advertising campaigns in accordance with embodiments of the invention include a plurality of advertisements describing one or more products and/or services that are the subject(s) of the targeted search advertising campaign. The advertisements are targeted towards keywords and/or phrases (and/or the intent described by the keywords and/or phrases) provided by a search engine provider. In a variety of embodiments, phrases include one or more keywords; the phrases may or may not be grammatically correct. Keyword and phrase scoring devices in accordance with embodiments of the invention are configured to improve the performance of targeted search advertising campaigns by scoring the keywords utilized in the creation of the targeted search advertising campaign, allowing for the targeted search advertising campaign to be targeted towards keywords and/or phrases that have been identified as effective in previous (possibly related) targeted search advertising campaigns.

A variety of targeted search advertising products can be offered by search engine providers including display of a predetermined creative accompanying search results returned by a search engine in response to receipt of a query containing a relevant keyword, and/or display of structured data (e.g. a product listing advertisement) as part of the search results returned by a search engine in response to receipt of query containing a relevant keyword. Systems and methods for creating targeted search advertising campaigns that can be utilized in accordance with embodiments of the invention are disclosed in U.S. patent application Ser. No. 13/424,373, titled “Taxonomy Based Targeted Search Advertising” to Zimmerman et al., filed Mar. 19, 2012, the entirety of which is incorporated by reference. In many embodiments, generating a targeted search advertising campaign utilizes a sematic model. The term semantic model is used to describe a particular scheme for classifying products and/or services. Collectively products and/or services (indeed any object, person, idea, or action) can be referred to as a concept and, in many embodiments, concepts can be defined in terms of categories and attribute value pairs. In this way, a semantic model used to build targeted search advertising campaigns can also include elements of an ontology (and/or a taxonomy) in the sense that the possible attributes of classified concepts can also be specified as can the relationships between those attributes.

Keyword and phrase scoring devices in accordance with embodiments of the invention are configured to score keywords and/or phrases utilized in semantic models and/or in targeted search advertising campaigns. Keyword and phrase scoring devices are configured to score the keywords used to search for the products and/or services based upon a training language model and a shared phrase key database. In several embodiments, a semantic model is constructed based upon the scored keywords. The semantic model can also be used to identify relationships between keyword components and the categories and attributes within the semantic model and these relationships, along with the scored keywords, are used to identify potentially relevant keywords for use in targeting a search advertising campaign with respect to specific concepts defined by the categories and attributes within the semantic model. In a number of embodiments, a set of products and/or services (i.e. concepts) advertised via one or more websites along with a list of scored keywords relevant to the products and/or services are processed to generate a semantic model. In several embodiments, the scored keywords include scored keyword phrases, where a keyword phrase includes one or more keywords and an associated phrase score.

Keyword and phrase scoring devices are configured to score keywords/and or phrases by identifying attributes within a set of unscored keywords and/or phrases and using the attributes to generate a keyword model based on a phrase key database. A training language model including keyword performance data is generated based on language model performance data and the phrase key database. Language model performance data can include, but is not limited to, keywords, phrases, and historical performance data associated with the keywords and phrases. The keyword and phrase scoring device is configured to score the keywords and/or phrases based on the keyword model and the training language model. In a variety of embodiments, the keyword and phrase scoring device is configured to update the training language model based on the scored keywords and/or phrases. In many embodiments, the keyword and phrase scoring device is configured to create and/or update a semantic model based on the scored keywords. In several embodiments, the keyword and phrase scoring device is configured to transmit the semantic model and/or the scored keywords to an advertising server to be utilized in the creation and/or updating of semantic models and/or targeted search advertising campaigns based on the scored keywords and products and/or services targeted by the intent associated with the scored keywords.

Systems and methods for scoring keywords and phrases utilized in targeted search advertising campaigns in accordance with embodiments of the invention are discussed below.

### Targeted Search Advertising Systems

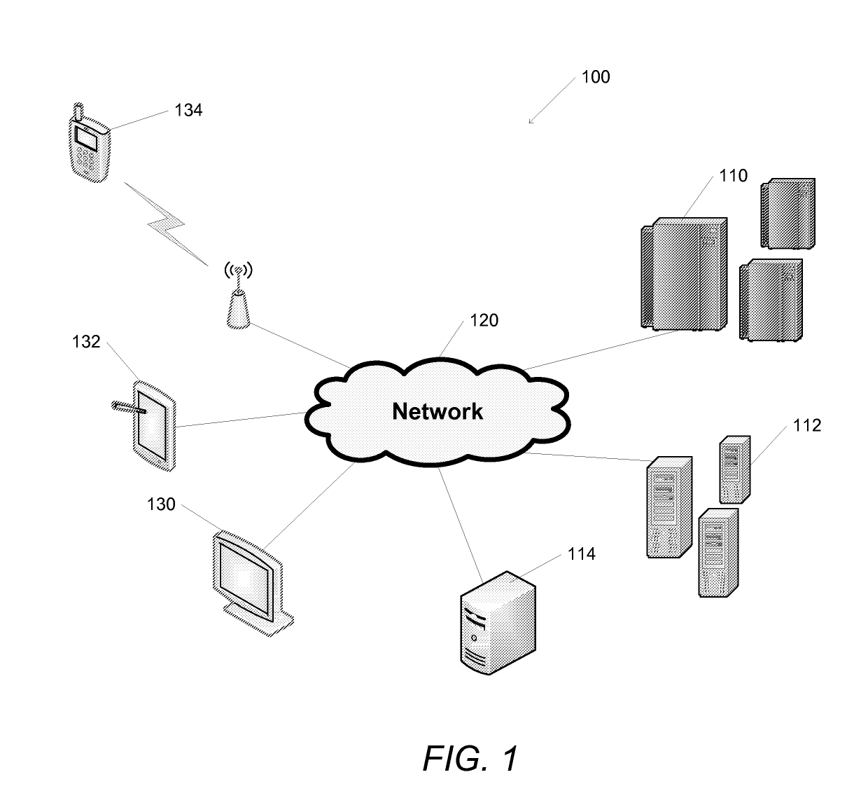

Targeted advertising systems are configured to deliver advertisements contained in or generated from advertising campaigns to user devices. Advertising systems utilized in search engine marketing are configured to deliver advertisements corresponding to the intent expressed in a search query. Targeted search advertising systems in accordance with many embodiments of the invention are configured to create targeted search advertising campaigns based on scored keywords and/or phrases derived from search terms used to search for the products and/or services that are the target of the search advertising campaign and deploy those targeted search advertising campaigns to search engine providers. A diagram of a targeted search advertising system in accordance with an embodiment of the invention is shown in FIG. 1. The targeted advertising system 100 includes an advertising server system 110, a keyword and phrase scoring device 112, a search engine provider 114, and user devices including computers 130, tablets 132, and mobile phones 134 configured to communicate via a network 120. In a variety of embodiments, the network 120 is the Internet.

The search engine provider 114 is configured to present targeted advertisements to the user devices based on keywords and/or phrases contained in search queries provided by the user devices to the search engine provider 114. The keyword and phrase scoring device 112 is configured to obtain the unscored keywords and/or phrases used in the search queries and generate scored keywords and/or phrases utilizing a training language model and a phrase key database. The advertising server system 110 is configured obtain the scored keywords and/or phrases from the keyword and phrase scoring device 112, generate and/or update targeted search advertising campaigns based on the scored keywords and/or phrases, and provide the generated campaigns to the search engine provider 114.

In a variety of embodiments, the advertising server system 110 and/or the keyword and phrase scoring device 112 are implemented using a single server system. In several embodiments, the advertising server system 110 and/or the keyword and phrase scoring device 112 are implemented using multiple server systems. In a number of embodiments, the keyword and phrase scoring device 114 includes a keyword scoring device and a training model generation device, where the training model generation device is configured to create a training language model based on a phrase key database shared with the keyword scoring device. The keyword scoring device is configured to obtain the unscored keywords and/or phrases and score the keywords and/or phrases based on the training language model obtained from the training model generation device and the shared phrase key database. In this way, the generation of the training language model and the scoring of keywords linked together via the shared phrase key database. Other configurations of the keyword and phrase scoring device 114 can be utilized as appropriate to the requirements of a specific application in accordance with embodiments of the invention.

Although a specific architecture of a targeted advertising system in accordance with embodiments of the invention are discussed above and illustrated in FIG. 1, a variety of architectures, including user devices not specifically named and other methods of serving targeted search advertising campaign information to user devices, can be utilized in accordance with embodiments of the invention. Systems and methods for scoring keywords and phrases for use in targeted search advertising campaigns are discussed below.

### Keyword and Phrase Scoring Devices

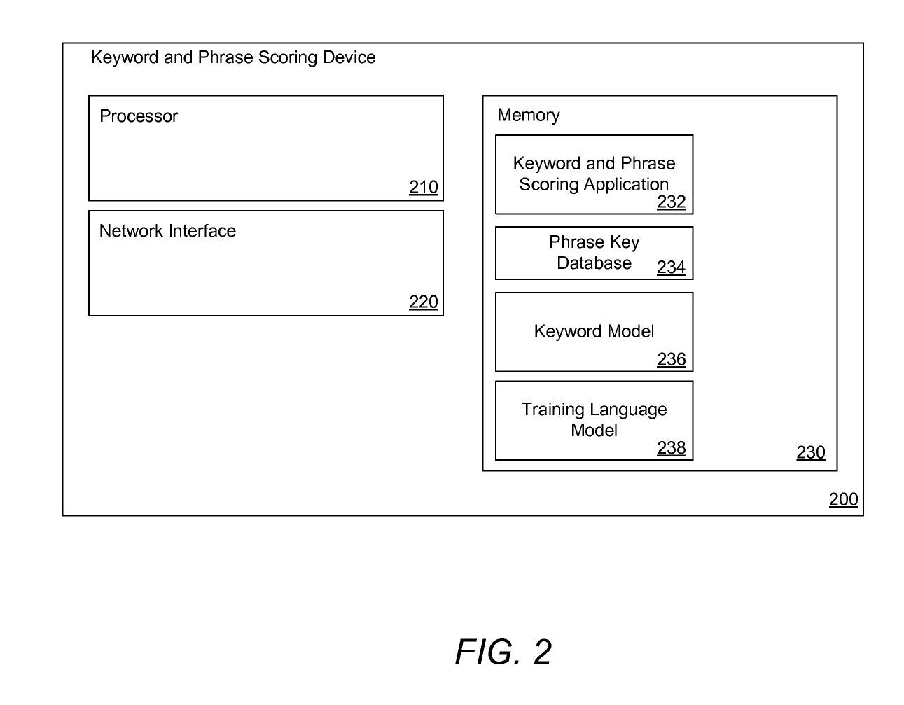

Keyword and phrase scoring devices in accordance with embodiments of the invention are configured to score unscored keywords and/or phrases based on a training language model and a shared phrase key database. A conceptual illustration of a keyword and phrase scoring device in accordance with an embodiment of the invention is shown in FIG. 2. The keyword and phrase scoring device 200 includes a processor 210 in communication with memory 230. The keyword and phrase scoring device 200 also includes a network interface 220 configured to send and receive data over a network connection. In a number of embodiments, the network interface 220 is in communication with the processor 210 and/or the memory 230. In several embodiments, the memory 230 is any form of storage configured to store a variety of data, including, but not limited to, the keyword and phrase scoring application 232, phrase key database 234, the keyword model 236, and/or training language model 238. In many embodiments, the keyword and phrase scoring application 232, the phrase key database 234, the keyword model 236, and/or the training language model 238 are stored using an external server system and received by the keyword and phrase scoring device 200 using the network interface 220.

The processor 210 is configured by the keyword and phrase scoring application 232 to obtain unscored keywords and/or phrases and score keywords and/or phrases based on the phrase key database 234 and the training language model 238. The keyword and phrase scoring application 232 configures the processor 210 to generate a keyword model 236 based on the unscored keywords and/or phrases and the phrase key database 234. The keyword and phrase scoring application further configures the processor to create a training language model 238 based on obtained keyword performance data and the phrase key database 234. In many embodiments, the phrase key database 234 includes phase key data including an input phrase and a mapping between components of the input phrase and unique identifiers that are assigned to them. A component of the input phrase can be either a token that appeared in the input phrase or a sub-phrase of the input phrase as described by the semantic model. In a variety of embodiments, the phrase key database abstracts the language model training data from the contents of the training data. The keyword and scoring application 232 also configures the processor 210 to generate scored keywords based on the keyword model and the training language model; these scored keywords are utilized to create and/or update semantic models and/or targeted search advertising campaigns. In a number of embodiments, the keyword and phrase scoring application 232 configures the processor 210 to identify additional keyword performance data based on the scored keywords and update the performance data and/or the training language model 238 based on the additional keyword performance data.

Although a specific architecture for a phrase and keyword scoring device device in accordance with an embodiment of the invention is conceptually illustrated in FIG. 2, any of a variety of architectures, including those which store data or applications on disk or some other form of storage and are loaded into memory 230 at runtime and systems that are distributed across multiple physical servers, can also be utilized in accordance with embodiments of the invention. Methods for scoring keywords and/or phrases utilizing training language models in accordance with embodiments of the invention are discussed below.

### Scoring Keywords and Phrases Using Training Language Models

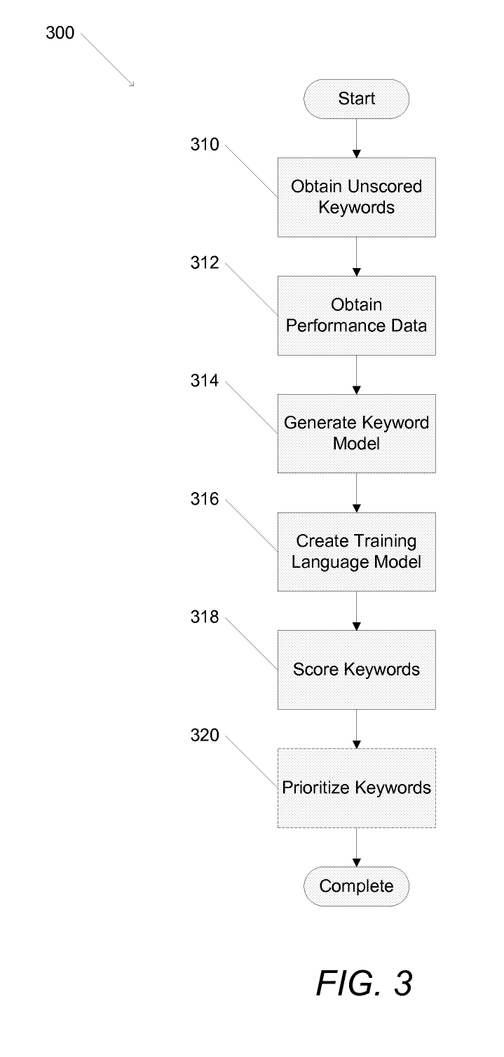

Targeted search advertising campaigns can include keywords and phrases included in search queries for products and/or services that are targeted towards the products and/or services being advertised in the targeted search advertising campaign. By scoring the keywords and phrases, the advertisements in the targeted search advertising campaign can be accurately targeted towards particular keywords that appear in anticipated search queries and/or the keywords that are likely to yield click-through and/or conversion. A process for scoring keywords and/or phrases using a language training model in accordance with an embodiment of the invention is illustrated in FIG. 3. The process 300 includes obtaining (310) unscored keywords. Performance data is obtained (312). A keyword model is generated (314). A training language model is created (316). The keywords and/or phrases are scored (318). In several embodiments, the scored keywords are prioritized (320).

In a variety of embodiments, the unscored keywords are obtained (310) from a search engine provider and/or an advertising server system. In many embodiments, the unscored keywords are obtained (310) via a manual process. In a number of embodiments, performance data is obtained (312) from an advertising server system based on the performance of one or more keywords in a variety of existing targeted search advertising campaigns, although the performance data can be obtained (312) from any source, including manual sources, in accordance with embodiments of the invention. In many embodiments, the obtained (312) performance data is language model performance data including category and attribute data with associated keywords and keyword performance data. Other information can be included in the obtained (312) performance data and the existing targeted search campaigns may or may not be related to the obtained (310) unscored keywords as appropriate to the requirements of a specific application in accordance with embodiments of the invention. In several embodiments, the keyword model is generated (314) based on the obtained (310) keywords and/or phrases and corresponding phrase keys in the phrase key database. In a variety of embodiments, the training language model is created (316) based on the obtained (312) performance data and the phrase key database. The keywords are scored (318) based on the generated (314) keyword model and the created (316) training language model. In many embodiments, the generated (314) keyword model and/or the created (316) training language model are represented using berkeleylm from the University of California-Berkeley of Berkeley, Calif., which is an n-gram language model. Other models can be utilized to represent the keyword model and/or the training language model as appropriate to the requirements of a specific application in accordance with embodiments of the invention. In a variety of embodiments, the scored (318) keywords are prioritized (320) based on the frequency that the keywords and/or phrases appear within search queries associated with the targeted search advertising campaign. In many embodiments, keywords are also prioritized based upon other performance metrics including (but not limited to) click-through rate and conversion rate. In a variety of embodiments, keyword frequency data is described using keyword frequency metadata. Other techniques for prioritizing (320) the scored keywords can be utilized as appropriate to the requirements of a specific application in accordance with embodiments of the invention.

Although a specific process for scoring keywords and/or phrases using a training language model in accordance with embodiments of the invention is described above with respect to FIG. 3, any number of processes can be utilized in accordance with embodiments of the invention. Processes for generating keyword models and training language models in accordance with embodiments of the invention are described below.

### Generating Keyword Models

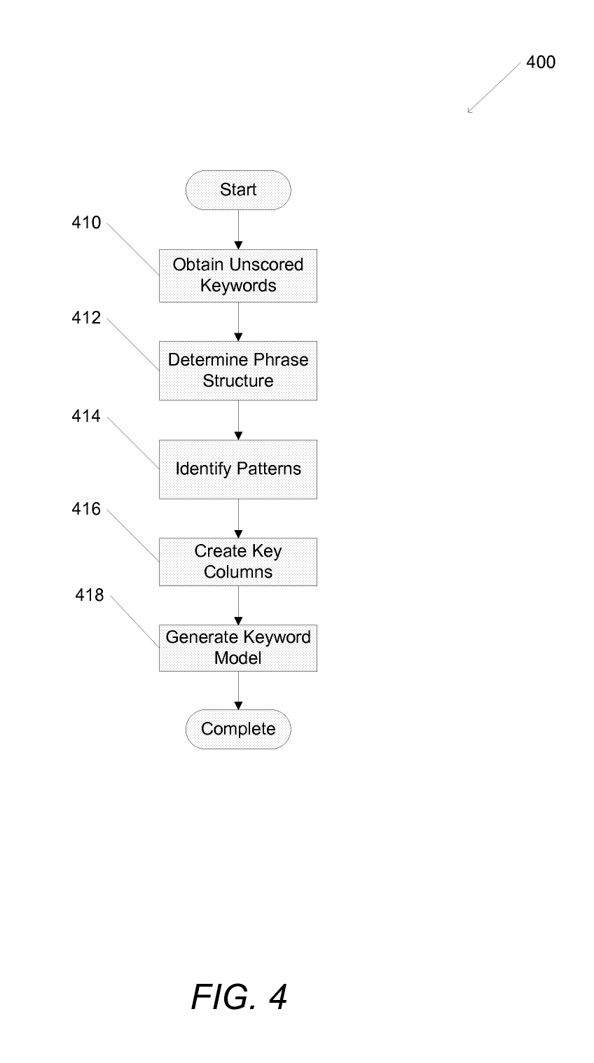

The scoring of keywords and/or phrases identifies the relevance and/or value of the keyword and/or phrases to one or more targeted search advertising campaigns. By identifying high performing keywords and/or phrases, targeted search advertising campaigns can be generated based on the performance of the keywords within the campaign. Keyword and phrase scoring devices in accordance with embodiments of the invention are configured to generate keyword models representing the structure of attributes within the keywords and/or phrases in the process of scoring the keywords and/or phrases. A process for generating keywords models in accordance with an embodiment of the invention is illustrated in FIG. 4. The process 400 includes obtaining (410) unscored keywords and/or phrases. A phrase structure is determined (412). Patterns are identified (414). Key columns are created (416) and a keyword model is generated (418).

In a number of embodiments, unscored keywords are obtained (410) utilizing processes similar to those described above. In many embodiments, determining (412) a phrase structure includes identifying one or more attributes based on the obtained (410) keywords and/or phrases. Attributed can be identified utilizing the attributes, values, and/or concepts contained in a semantic model, where the semantic model provides a mapping from the phrasal form of an attribute to its canonical form and assigns semantic types to each identified attribute. This allows input phrases to be represented as sequences of annotated phrase components where the annotations are canonical forms and semantic types. Other techniques can be utilized as appropriate to the requirements of a specific application in accordance with embodiments of the invention. In several embodiments, the attributes are identified using phrase key data stored in a phrase key database. In a variety of embodiments, identifying (414) patterns within the determined (412) phrase structure and/or the obtained (410) keywords and/or phrases includes identifying (414) phrase patterns, concept patterns, and/or grammar patterns. Other patterns can be identified (414) within the keywords, phrases, and/or phrase structure as appropriate to the requirements of a specific application in accordance with embodiments of the invention. In several embodiments, key columns are created (416) based on the identified (414) patterns. In several embodiments, a key column is a list of phrase keys from the shared phrase key database that can appear within an identified pattern. In many embodiments, the shared phrase key database allows for the generation of training data models at a variety of levels of abstraction; in a variety of embodiments, the levels of abstraction are related to the keyword models. In a number of embodiments, generating (418) the keyword model includes associating one or more of the obtained (410) keywords and/or phrases with the created (416) key columns.

Although a specific process for generating a keyword model using unscored keywords and a phrase key database in accordance an embodiment of the invention is discussed above with respect to FIG. 4, a variety of processes, including those generating multiple keyword models, can be utilized in accordance with embodiments of the invention. Processes for generating training language models in accordance with embodiments of the invention are described below.

### Creating Training Language Models

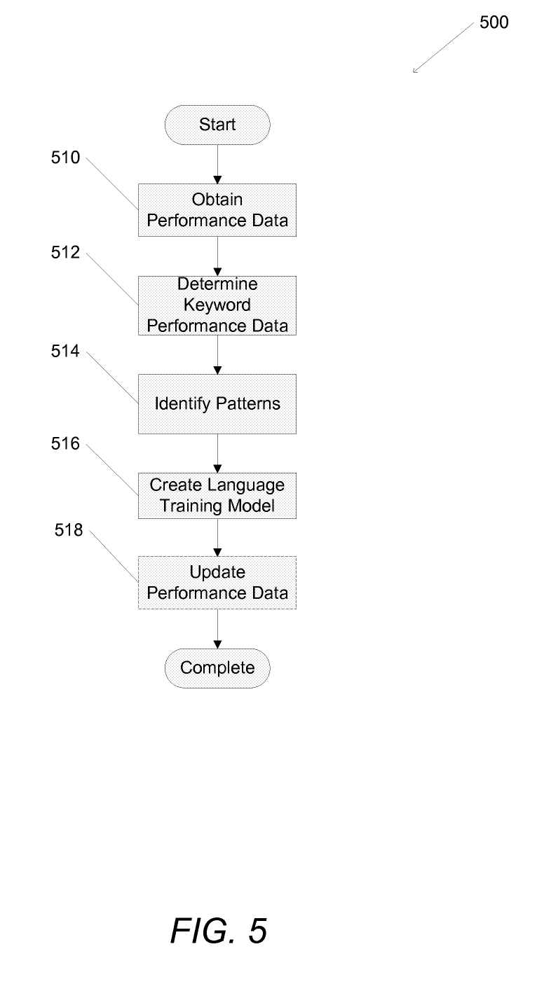

Training language models are configured to associate keywords with historical performance data. In this way, training language models can be used to score keywords and/or phrases used in the creation and/or modification of targeted search advertising campaigns. A process for creating a training language model in accordance with an embodiment of the invention is illustrated in FIG. 5. The process 500 includes obtaining (510) performance data. Keyword performance data is determined (512). Patterns are identified (514) and a language training model is created (516). In a number of embodiments, the performance data is updated (518).

In many embodiments, performance data is obtained (510) using processes similar to those described above. In a variety of embodiments, determining (512) keyword performance data includes identifying attributes based on the keywords associated with the obtained (510) performance data and corresponding phrase keys in a phrase key database. A variety of training language models include training data based on click counts and/or impression counts for each keyword described in the training language models based on the phrase keys in the phrase key database. In several embodiments, identifying (514) patterns is performed using processes similar to those described above. In a variety of embodiments, identifying (514) patterns includes determining a count of the number of identified (514) patterns. In certain embodiments, the language training model is created (516) based on the identified (514) patterns and the determined (512) keyword performance data. In several embodiments, the language model is created (516) based on the number of patterns identified (514). In many embodiments, the performance data is updated (518) based on the created (516) training language model and/or the identified (514) patterns.

A specific process for generating training language models in accordance with an embodiment of the invention is discussed above; however, a variety of processes can be utilized to generate training language models, including those that generate multiple training language models, in accordance with embodiments of the invention.

Although the present invention has been described in certain specific aspects, many additional modifications and variations would be apparent to those skilled in the art. It is therefore to be understood that the present invention can be practiced otherwise than specifically described without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A keyword and phrase scoring device, comprising:
a processor;
a memory connected to the processor and configured to store a keyword and phrase scoring application;
a shared phrase key database configured to store phrase key data; and
performance data storage configured to store language model performance data comprising category and attribute data with associated keywords and keyword performance data;
wherein the keyword and phrase scoring application configures the processor to:
obtain a plurality of unscored keywords;
identify keyword patterns in a portion of the plurality of unscored keywords;
generate a keyword model based on a set of key columns, where the key columns are based on phrase keys contained within the identified patterns and corresponding phrase key data contained within the shared phrase key database;
create a training language model incorporating phrase key data from the key columns using category and attribute data within the language model performance data matching phrase key data contained within the shared phrase key database; and
score the plurality of unscored keywords based on the keyword model and the training language model.

2. The system of claim 1, wherein the keyword and phrase scoring application further configures the processor to:
determine at least one phrase structure within the plurality of unscored keywords; and
identify keyword patterns in a portion of the plurality of unscored keywords based on the at least one phrase structure.

3. The system of claim 2, where the identified keyword patterns are selected from the group consisting of phrase patterns, concept patterns, and grammar patterns.

4. The system of claim 1, wherein the keyword and phrase scoring application further configures the processor to:
extract a plurality of performance keywords from the language model performance data based on the shared phrase key database;
identify one or more patterns within the plurality of performance keywords; and
create the language training model based on the identified patterns.

5. The system of claim 4, wherein the keyword and phrase scoring application further configures the processor to count the number of patterns within the plurality of performance keywords.

6. The system of claim 1, wherein the keyword and phrase scoring application further configures the processor to update the language model performance data based on the scored keywords.

7. The system of claim 1, wherein the keyword and phrase scoring application further configures the processor to update the language model performance data based on the created language training model.

8. The system of claim 1, wherein the keyword and phrase scoring application further configures the processor to:
obtain keyword frequency metadata, where the keyword frequency metadata comprises the number of times one or more keywords have been received by a search engine provider; and
prioritize the scored keywords based on the keyword frequency metadata.

9. The system of claim 8, wherein:
the keyword frequency metadata further comprises performance metrics related to the number of times an advertisement has been displayed based on a search query containing the one or more keywords by the search engine provider; and
the performance metrics are selected from the group consisting of a click-through rate and a conversion rate.

10. The system of claim 1, wherein the keyword and phrase scoring application further configures the processor to transmit the scored keywords to an advertising server system.

11. A method for scoring phrases, comprising:
obtaining a plurality of unscored keywords using a keyword and phrase scoring device;
identifying keyword patterns in a portion of the plurality of unscored keywords using the keyword and phrase scoring device;
generating a keyword model based on a set of key columns using the keyword and phrase scoring device, where the key columns are based on phrase keys contained within the identified patterns and corresponding phrase key data contained within the shared phrase key database;
creating a training language model incorporating phrase key data from the key columns based on category and attribute data within the language model performance data matching phrase key data contained within the shared phrase key database using the keyword and phrase scoring device; and
scoring the plurality of unscored keywords based on the keyword model and the training language model using the keyword and phrase scoring device.

12. The method of claim 11, further comprising:
determining at least one phrase structure within the plurality of unscored keywords using the keyword and phrase scoring device; and
identifying keyword patterns in a portion of the plurality of unscored keywords based on the at least one phrase structure using the keyword and phrase scoring device.

13. The method of claim 12, where the identified keyword patterns are selected from the group consisting of phrase patterns, concept patterns, and grammar patterns.

14. The method of claim 11, further comprising:
extracting a plurality of performance keywords from the language model performance data based on the shared phrase key database using the keyword and phrase scoring device;
identifying one or more patterns within the plurality of performance keywords using the keyword and phrase scoring device; and
creating the language training model based on the identified patterns using the keyword and phrase scoring device.

15. The method of claim 14, further comprising counting the number of patterns within the plurality of performance keywords using the keyword and phrase scoring device.

16. The method of claim 11, further comprising updating the language model performance data based on the scored keywords using the keyword and phrase scoring device.

17. The method of claim 11, further comprising updating the language model performance data based on the created language training model using the keyword and phrase scoring device.

18. The method of claim 11, further comprising:
obtaining keyword frequency metadata using the keyword and phrase scoring device, where the keyword frequency metadata comprises the number of times one or more keywords have been received by a search engine provider; and
prioritizing the scored keywords based on the keyword frequency metadata using the keyword and phrase scoring device.

19. The method of claim 18, wherein:
the keyword frequency metadata further comprises performance metrics related to the number of times an advertisement has been displayed based on a search query containing the one or more keywords by the search engine provider; and
the performance metrics are selected from the group consisting of a click-through rate and a conversion rate.

20. The method of claim 11, further comprising transmitting the scored keywords to an advertising server system using the keyword and phrase scoring device.
